(19) United States
(12) Patent Application Publication
(10) Pub. No.: US 2003/0015483 A1
(43) Pub. Date: Jan. 23, 2003

(54) Black water filter for high ash containing feedstock

(75) Inventors: R. Judy Hwan, Sugar Land, TX (US); Frederick B. Seufert, Houston, TX (US)

Correspondence Address: STEPHEN H. CAGLE, HOWREY, SIMON, ARNOLD & WHITE, LLP, 750 BERING DRIVE, HOUSTON, TX, 77057, US

(73) Assignee: Texaco Inc.

(21) Appl. No.: 09/909,022

(22) Filed: Jul. 19, 2001

(51) Int. Cl. C02F 1/00; B01D 21/02

(52) U.S. Cl. 210/800; 210/513

(57) ABSTRACT

The present invention involves the addition of a black water filter to the outlet of the quench chamber of the gasification reactor. The normal flow of water out of the gasification reactor is through the side of the quench chamber, but in the present invention it leaves out the bottom of the quench chamber into the black water filter. In the black water filter, slag in the black water is allowed to settle out. Soot water exits the top of the black water filter and flows to downstream purification/processing units.

### BACKGROUND OF THE INVENTION

High pressure, high temperature gasification systems have been used to partially oxidize hydrocarbonaceous fuels to recover useful by-products or energy. The fuels can be admixed with water to form an aqueous feedstock that is fed to the reaction zone of a partial oxidation gasifier along with a oxygen containing gas and a temperature moderator.

Mixing the feed with water may not be necessary, given the composition and physical nature of the feedstock. Generally, solid carbonaceous fuels will need to be liquefied with oil or water prior to feeding to the gasifier. Liquid and gaseous hydrocarbonaceous fuels may be suitable for direct feed to the gasifier, but can be pretreated for removal of any impurities that might be present in the feed.

The term liquid hydrocarbonaceous fuel as used herein to describe various suitable feedstocks is intended to include pumpable liquid hydrocarbon materials and pumpable liquid slurries of solid carbonaceous materials, and mixtures thereof. In fact, any combustible carbon-containing liquid organic material, or slurries thereof may be included within the definition of the term “liquid hydrocarbonaceous.” For example, there are pumpable slurries of solid carbonaceous fuels, liquid hydrocarbon fuel feedstocks, oxygenated hydrocarbonaceous organic materials, and mixtures thereof. Gaseous hydrocarbonaceous fuels may also be burned in the partial oxidation gasifier alone or along with liquid hydrocarbonaceous fuel.

The partial oxidation reaction is preferably carried out in a free-flow, unpacked non-catalytic gas generator, or gasifier at a temperature within the range of about 700° C. to about 2000° C., preferably about 1200° C. to about 1500° C. The gasifier operates at a pressure of about 2 to about 250 atmospheres, preferably about 10 to about 150 atmospheres, and most preferably about 20 to about 90 atmospheres. Under these conditions, about 95% to 99.99% of the hydrocarbonaceous feedstock can be converted to a synthesis gas containing carbon monoxide and hydrogen, also referred to as synthesis gas or syngas. Carbon dioxide and water are either formed or consumed via water gas shift reaction [CO+H₂O [symbol] CO₂+H₂] depending on the type of the moderator employed and operating conditions.

Water is further used as quench water to quench and cool the syngas. In a typical gasification reactor, the effluent gas passes out the bottom of the gasification reactor into a quench chamber. The effluent gas is cooled by passing through a pool of quench water. The quench water cools the syngas and scrubs particulate matter from the syngas, and is further used to convey particulate waste solids, such as ash and/or slag out of the gasifier. Generally, ash and/or slag is allowed to accumulate in the bottom of the quench chamber, and periodically that ash and/or slag is removed from the quench chamber using a lockhopper system. The quench water is continuously circulated in the quench chamber, being removed from the quench chamber at an outlet port below the level of the quench water. The syngas leaves the quench chamber through an outlet port above the level of the quench water.

Referring to FIG. 1, a typical prior art gasification unit is shown. Hydrocarbonaceous fuel, a temperature moderator, and an oxygen containing gas are fed through lines 2, 4 and 6 to gasification reactor 10 via feed injector 8. In the reaction section 12 of the gasification reactor 10 the feed streams react to form syngas. The syngas passes out the bottom of the reaction section 12 into a pool of quench water 14 in the quench chamber 16 of the gasification reactor 10. The pool of quench water 14 has a level 18 that is higher than the inlet of the syngas. The syngas bubbles through the quench water 14, and exits the quench chamber 16 through outlet port 26. Fresh quench water is fed to the quench chamber 16 through inlet port 20 into the quench ring 27, and is removed through outlet port 22. After being removed from the quench chamber 16, the quench water, now referred to as soot water, is sent to a soot recovery unit for separation of soot from the water. The recovered soot can either be recycled as a soot-oil slurry after treatment in a traditional naphtha extraction unit or rejected as a filter cake. Alternately, a portion of the soot water stream can be recycled directly to the gasification reactor 10 as a moderator stream. After being treated, the recovered, water is usually recycled back to the quench chamber of the gasifier. Ash and/or slag accumulates in the bottom of the quench chamber 16, and is periodically removed by opening valve 24 and sending the ash and/or slag to a lockhopper system (not shown). The mixture of ash and/or slag and water is commonly referred to as black water.

When processing high ash content gasifier feedstocks, most of the inorganic material in the feed is converted into a vitreous slag. Although this slag is usually directly removed from the gasifier after the syngas is quenched with process water, some slag does build up on the walls of the gasifier reaction chamber 12 and accumulates in the bottom of the quench chamber 14. The slag builds up in the bottom of the gasification quench chamber often gets carried out through the outlet port 22 and plugs the downstream equipment. The material that accumulates on the walls of the gasifier reaction chamber 12 remains inside the reaction chamber until the gasifier is shutdown and exposed to air. Then the slag oxidizes and melts, causing the slag to flow into the quench chamber, plugging the gasifier dip tube 29 and outlet port 22.

The composition of the soot water discharged from the gasification system is fairly complex. This water can contain chlorides, ammonium salts, and other potentially environmentally harmful dissolved materials such as sulfide and cyanide. The grey water is usually treated to remove these compounds. Other compounds found in the slag, particularly heavy metals such as Vanadium and Nickel, are more difficult to remove. Excess slag accumulation in the soot water and downstream soot water treatment units can cause serious operating problems in the entire gasification unit operation. Because hard to treat compounds, such as heavy metals, can build up in the soot water, it would be desirable to develop a process that would greatly facilitate the removal of slag from the soot water.

### SUMMARY OF THE INVENTION

The present invention involves the addition of a black water filter to the outlet of the quench chamber of the gasification reactor. In the present invention black water leaves out the bottom of the quench chamber into the black water filter. In the black water filter, slag in the black water is allowed to settles out of the black water. Soot water exits the top of the black water filter and flows to downstream purification/processing units. During shutdown period, the black water filter can also be used to collect the slag that melts and flows into the gasifier reaction chamber.

### BRIEF DESCRIPTION OF THE DRAWINGS

FIG. 1 illustrates a common prior art gasification unit.

FIG. 2 shows a preferred embodiment of the present invention.

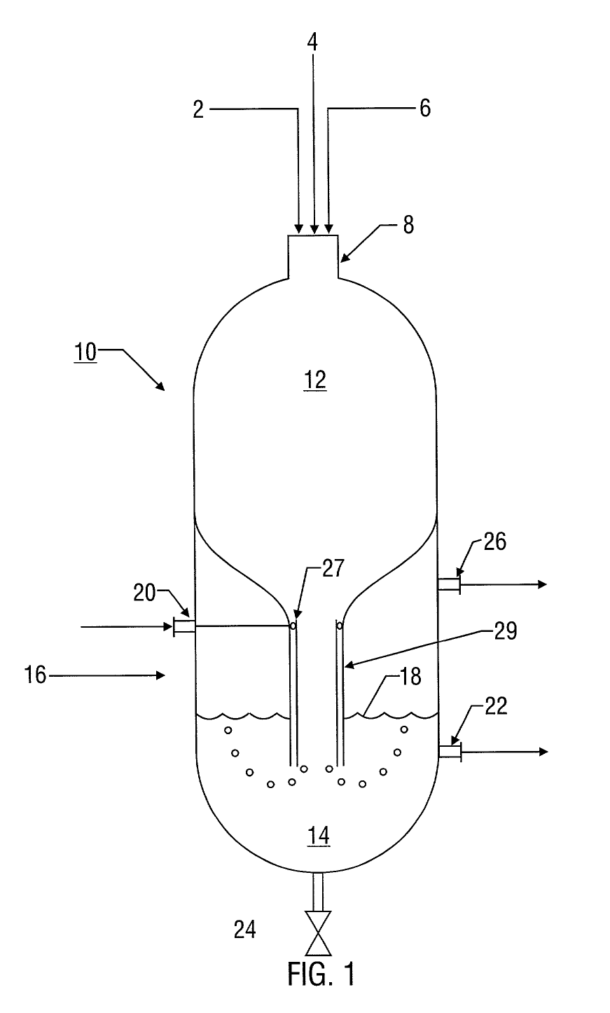

### DESCRIPTION OF ILLUSTRATIVE EMBODIMENTS

The present invention involves the addition of a black water filter to the outlet of the quench chamber of the gasification reactor. The normal flow of water out of the gasification reactor is through the side of the quench chamber, but in the present invention it leaves out the bottom of the quench chamber into the black water filter. In the black water filter, more of the slag in the black water settles out. The soot water exits the top of the black water filter and then flows to downstream purification/processing units.

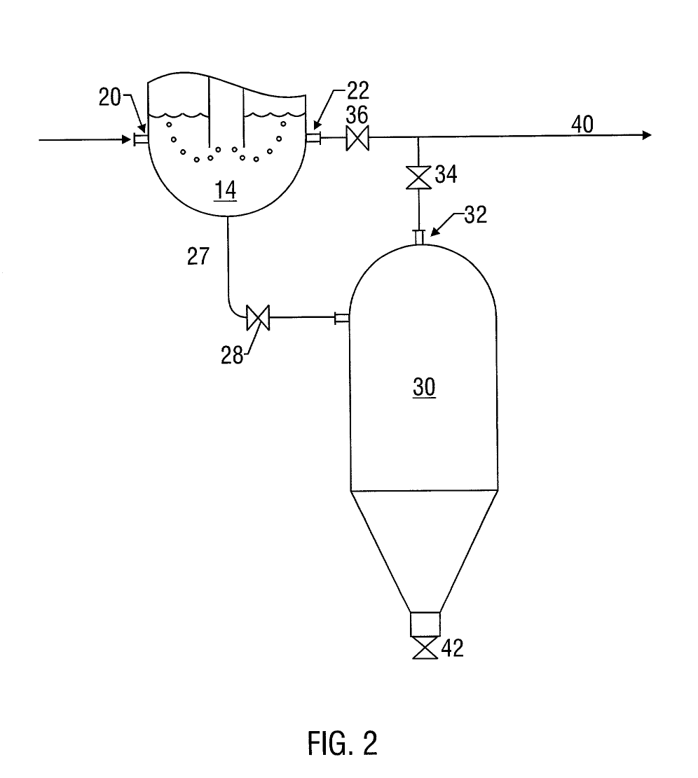

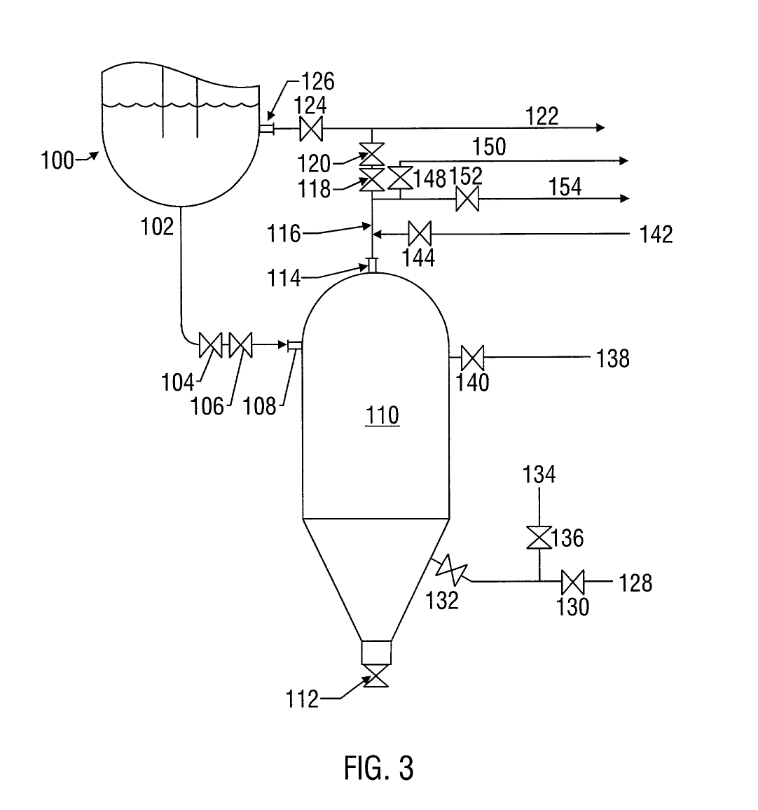

Referring now to FIG. 2, one embodiment of the present invention is shown. The quench chamber 16 of a gasifier is shown, but in contrast to the prior art, the normal outlet of the quench water through outlet port 22 is blocked by closing valve 36. The quench water is instead removed through the bottom of the quench chamber through line 27. The quench water, or black water, passes through valve 28 into black water filter 30. In black water filter 30, the ash and/or slag is allowed to settle into the lower conical section of the filter 30. The soot water leaves out the top of the black water filter 30 through outlet port 32, passes through valve 34, and joins with line 40 to be sent to the downstream soot water purification/processing units. The black water filter 30 occasionally needs to be emptied of slag, and this is accomplished by returning the quench chamber to its normal operation. This is done by opening valve 36 and closing valves 28 and 34, isolating the black water filter 30. Then valve 42 can be opened, allowing for the removal of the ash and/or slag.

FIG. 3 shows another embodiment of the present invention. Black water is removed through line 102 from quench chamber 100, and passes through valves 104 and 106 before entering black water filter 110 through inlet port 108. In black water filter 110 the ash and/or slag is allowed to settle into the lower portion of the filter, while soot water leaves through outlet port 114, through line 116 and valves 118 and 120, and then into line 122 where it is sent to downstream purification/processing units. Valve 124 is normally closed so that no black water can leave the quench chamber 100 through outlet port 126.

When it is time to dump the accumulated slag from the black water filter, valve 124 is opened and valves 104 and 106 are closed. This allows for the black water to leave the quench chamber 100 through outlet port 126, and then into line 122 where it is sent directly to downstream purification/processing units, bypassing the black water filter 110. High pressure grey water through 128 is introduced into the black water filter by opening valves 130 and 132. This assists in cooling the accumulated slag in the black water filter. When the outlet temperature of the water leaving the black water filter, measured at some point in line 116, reaches a specified temperature, preferably 165° C. or cooler, valve 130 is closed, shutting off the grey water flow to the black water filter.

Valve 136 is then opened, allowing demineralized water to flow through line 134 into the black water filter 110 to further cool the slag. When the outlet temperature of the water leaving the black water filter reaches a second specified temperature, preferably about 70° C. or cooler, valves 132 and 136 are closed, shutting off the flow of the demineralized water to the black water filter. Valves 118 and 120 are then closed, completely isolating black water filter 110.

Valve 152 is then opened so as to depressure the black water filter 110. When the pressure in the black water filter is reduced to an acceptable level, preferably near about zero bar gauge, valve 152 is closed. Valve 112 is then opened so that the accumulated slag in the black water filter can be dumped. Low pressure nitrogen may be introduced through line 142 by opening valve 144, which helps to sweep the accumulated slag out of the black water filter.

Once the black water filter 110 is empty, valves 112 and 144 are closed, and valves 140 and 148 are opened. This allows water to flow through line 138 into the black water filter. Once water is observed leaving the black water filter through line 150, valves 140 and 148 should be closed. High pressure grey water is then introduced to the black water filter through line 128 by opening valves 130 and 132. Once the pressure in the black water filter is near the operating pressure of the gasification reactor, valves 130 and 132 are closed. Finally, the black water filter can be placed back in service by first opening valves 118 and 120, and then opening valves 104 and 106. Finally, valve 124 can be closed, forcing all the black water out the bottom of the quench chamber 100 and into the black water filter 110.

While the apparatus and methods of this invention have been described in terms of preferred embodiments, it will be apparent to those of skill in the art that variations may be applied to the process described herein without departing from the concept and scope of the invention. All such similar substitutes and modifications apparent to those skilled in the art are deemed to be within the scope and concept of the invention. In particular, it should be noted that although the preferred embodiments were described as a treatment for black water from a gasification reactor, the apparatus and methods of this invention can be used for any type of solids removal system for which this system may be useful.

What is claimed is:

1. A process comprising:
removing water through an outlet means on the bottom of a gasification reactor;
introducing the water into a filter, wherein solids in the black water are allowed to settle to the bottom of the filter; and
removing the water from filter through the top of the filter.

2. The process of claim 1 wherein the water is removed from a quench chamber of the gasification reactor.

3. The process of claim 1 wherein the solids are ash or slag generated in the gasification reactor.

4. The process of claim 1 further comprising removing the solids from the filter.

5. The process of claim 4, wherein the solids are removed after the filter is isolated from the gasification reactor.

6. A process for removing solids from a filter comprising:
stopping the flow of feed to the filter,
cooling the solids in the filter,
reducing the pressure inside the filter, and
removing the solids from the filter.

7. The process of claim 6, wherein the solids are cooled by running high pressure water through the filter.

8. The process of claim 7 wherein the high pressure water is high pressure grey water.

9. The process of claim 7 wherein the solids are cooled by the high pressure water to at or below a temperature of about 165° C.

10. The process of claim 9 wherein after the solids are cooled by the high pressure water to at or below a temperature of about 165° C., the flow of the high pressure water is stopped, and demineralized water is used to cool the solids in the filter.

11. The process of claim 10, wherein the solids are cooled by the demineralized water to a temperature at or below about 70° C.

12. The process of claim 6 wherein the pressure inside the filter is reduced to about zero bar gauge.

13. The process of claim 6 wherein low pressure nitrogen is introduced into the filter while the solids are being removed from the filter.

14. The process of claim 6, wherein after the solids have been removed from the filter, the filter is filled with water and pressurized to a pressure near the operating pressure of the gasification reactor.

15. The process of claim 14 wherein the water used to pressurize the filter is high pressure grey water.

16. The process of claim 14 wherein after the filter is pressurized feed is allowed to flow into the filter.
